(19) United States
(12) Patent Application Publication
(10) Pub. No.: US 2014/0089317 A1
(43) Pub. Date: Mar. 27, 2014

(54) ASSOCIATING OPERATIONS INFORMATION AND COMMUNICATIONS INFORMATION

(71) Applicant: Schlumberger Technology Corporation, Sugar Land, TX (US)

(72) Inventors: Hallgrim Ludvigsen, Stavanger (NO); Haifeng Wang, Stavanger (NO)

(73) Assignee: Schlumberger Technology Corporation, Suger Land, TX (US)

(21) Appl. No.: 14/093,575

(22) Filed: Dec. 2, 2013

Related U.S. Application Data
(63) Continuation-in-part of application No. 13/241,049, filed on Sep. 22, 2011.
(60) Provisional application No. 61/736,910, filed on Dec. 13, 2012.
(60) Provisional application No. 61/389,745, filed on Oct. 5, 2010.

(51) Int. Cl. G06F 17/30

(52) U.S. Cl. CPC G06F 17/30321
USPC 707/741

(57) ABSTRACT

A method can include providing operations information associated with a coordinate of a subterranean formation; associating communications information with the coordinate; indexing the provided operations information and the associated communications information; and storing a search index based at least in part on the indexing. Various other apparatuses, systems, methods, etc., are also disclosed.

### RELATED APPLICATION

This application claims the benefit of U.S. Provisional Patent Application having Ser. No. 61/736,910, filed 13 Dec. 2012; and this application also, is a continuation-in-part of a co-pending U.S. patent application Ser. No. 13/241,049, filed 22 Sep. 2011, which claims the benefit of U.S. Provisional Patent Application having Ser. No. 61/389,745, filed 5 Oct. 2010, which is incorporated by reference herein.

### BACKGROUND

Real-time well operations, such as drilling, tend to be handled by a team. Team members may have discrete roles, for example, one or more members may be on-site while one or more other members may be off-site. On-site tasks may include preparation and deployment of equipment while off-site tasks may include well design and well planning using modeling or other applications. Real-time well operations may take into consideration a well plan, monitored information, modeling information, safety information, economic information, etc. Team members may communication during real-time well operations or at other times to plan, assess, etc., well operations.

### SUMMARY

A method can include providing operations information associated with a coordinate of a subterranean formation and associating communications information with the coordinate. A system can include a search index module to index acquired operations information and communications information and a coordinate of a subterranean formation or a time of a communication. A computer-readable media that includes computer-executable instructions can in turn include instructions to instruct a computer to a provide a search index (e.g., for operations information and communications information), receive a query, identify a match for the query using the search index, and transmit a result responsive to the query based at least in part on the match. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating and optionally interacting with a geologic environment;

FIG. 2 illustrates an example of a system that includes a user layer, a private resource layer and a public resource layer and an example of another system;

FIG. 3 illustrates an example of a system that includes an entity layer, a data exchange layer and an applications layer;

FIG. 4 illustrates an example of a system that includes an operations dashboard module for operations information, a communications module for communications information and one or more data structures for associating information with a coordinate, a time or a coordinate and a time;

FIG. 5 illustrates an example of a system that includes an indexer to access various data sources and index data;

FIG. 6 illustrates an example of a system that includes an earth model application that can incorporate information associated with a communication;

FIG. 7 illustrates an example of a method to receive a query and to transmit results;

FIG. 8 illustrates an example of a system that includes an associations module for associating information;

FIG. 9 illustrates an example of a method for associating and indexing information;

FIG. 10 illustrates examples of methods; and

FIG. 11 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

During a real-time operation, such as drilling, a method may include capturing communication information (e.g., communication artifacts), for example, for communication occurring between one or more operation team members and one or more support team members. Such communication may occur in any of a variety of forms, for example, via IM chat, email, voice, video, etc. Communication artifacts may exist in any of a variety of forms, for example, IM chat transcript, email log, voice annotations, video, etc. Communication technologies can include, for example, technologies such as SKYPE® technologies (Skype Corporation, Luxembourg). SKYPE® technologies provide, for example, voice over Internet protocol (VOIP) peer-to-peer communications, electronic transmission of data and documents (e.g., over computer terminals), and instant messaging services. As another example of a communication technology, consider the TWITTER® microblogging service (Twitter, San Francisco, Calif.). As yet another example of a communication technology, consider the FACEBOOK® social network (Facebook, Palo Alto, Calif.).

As an example, a method may include tagging a captured artifact, for example, with time, time code (e.g., universal time code), current measured depth for a well operation (e.g., as a coordinate of a subterranean formation), current seismic line for a seismic operation (e.g., a shot, etc., which may be specified by or associated with a coordinate of a subterranean formation), point in space for a drill bit (e.g., a coordinate at a given time), one or more operation targets (e.g., well bore, etc.), etc. Such tagging may tag an artifact with information extracted from the context of an operation, a tool being used, etc. As an example, a coordinate may be a coordinate of a coordinate system and, as an example, coordinates that specify a distance (e.g., a depth), a point, a volume, a voxel, a seismic value in an array, etc. may be provided for association with other information. As an example, where a surface of a subterranean formation may be considered a base level, for example, at zero, a coordinate referenced from that level may specify depth (e.g., a direction downward from the base level into the subterranean formation). As an example, a coordinate system may be a Cartesian coordinate system, a cylindrical coordinate system, an Earth-based coordinate system (e.g., longitude, latitude. GPS coordinates, etc.), etc. As an example, where multiple coordinate systems exist, a mapping may optionally be applied, for example, to transform one or more coordinates from one coordinate system to another coordinate system.

As an example, a method may include storing a tagged artifact in a database (e.g., a knowledge base). Such a database may provide for associations of tagged artifacts with, for example, artifacts of a geology and geophysics model. A method may include indexing for purposes of search or other associations for tagged artifacts. As an example, the STUDIO E&P™ knowledge environment (Schlumberger Limited, Houston, Tex.) includes STUDIO FIND™ search functionality, which can provide an index(es) for content. Public content, private content or both may exist in one or more databases, which may be distributed and accessible via an intranet, the Internet or one or more other networks. As an example, a method may include a “dimensions of relevance” approach to information retrieval, for example, where relevance can refer to any of a variety of factors (e.g., valid, reliable, current, etc.). Search functionality may provide for searches directed to geographical area, problems encountered, solutions, best practices, project type (e.g., exploration, development, etc.), economic considerations, equipment implemented, equipment available, energy sources, lithology, etc.

With respect to geophysical models, as an example, a geophysical modeling application may include modules for modeling geological features, fluids (e.g., in one or more phases), pressures, compositions, stresses, equipment, etc. In an object-oriented application, such modules may include “domain objects”, for example, to represent a model in terms of geometry, physics, chemical physics, data or combinations thereof. Domain objects may collectively represent a reservoir model, for example, that may include planned well trajectories, actual wells, real-time logs, etc.

As an example, communication may occur between an operator and two clients (Client A and Client B). In such an example, communication may commence at a particular time and include communications (e.g., communications information) as follows:

17 October 20XX, 08:08 am (GMT+1):
Operator: I observe an anomaly on the periscope RX channel. Please advise.
Client A: I will ask our geologist to have a look. B: What is this?
Client B: I believe we see a karst infilled with low reservoir quality organic rich clay.
Client A: Adjust inclination +3 degrees to avoid.
Operator: Will adjust drilling plan due to karst observed on RX channel.

The foregoing communication session may include associated information, for example:

Well: A-16 (e.g., extracted from real-time steering application);

MD: 1232.54 meters (e.g., extracted from real-time visualization application);

Well GUID: ABC123 (e.g., extracted from modeling application); and

Reservoir model: Final_final_drillplan_nome_{—}9 (e.g., extracted from modeling application).

As an example, a method may process such information, for example, for performing post mortem knowledge mining, to look for analogous situations in a later operation, etc. For example, given search functionality, a user may enter search terms such as “well periscope” where a match may be made to well “A-16” based on captured, tagged artifacts in a communication (see, e.g., example transcript, above). As another example, for a search with terms datatype “reservoir model” and keyword “karst”, a match may be made to the model “Final_final_drillplan_nome_{—}9” based on capture and tagging of artifacts in a communication (see, e.g., example transcript, above). As yet another example, for a search with terms depth “>1200” and keyword “RX”, a match may be made to well “A-16” and model “Final_final_drillplan_nome_{—}9”, for example, based on an extracted depth from the “context” (e.g., in the model and communication transcript).

During execution of a well plan, information capture and tagging may help preserve knowledge, support understanding, facilitate future development of a well, etc. Where communication occurs, such communication by itself may help ensure proper execution of a well plan or modification thereof. Given search functionality, one or more members of a team may submit queries and receive results to understand better how to plan, execute, etc., one or more drilling operations. As an example, such functionality may help operators optimize factors such as bit use by providing estimates of how much further a bit travels, what type of material a bit travels through, conditions that may be encountered by the bit, etc.

As an example, a real-time process may include tagging and searching, for example, as a drill bit reaches a point in a subterranean formation, information associated with the drill bit, drilling process, etc. may be tagged and information associated with the drill bit, drilling process, etc. may be used to form one or more queries where a result or results of a query or queries may inform the real-time drilling process (e.g., as part of a control loop).

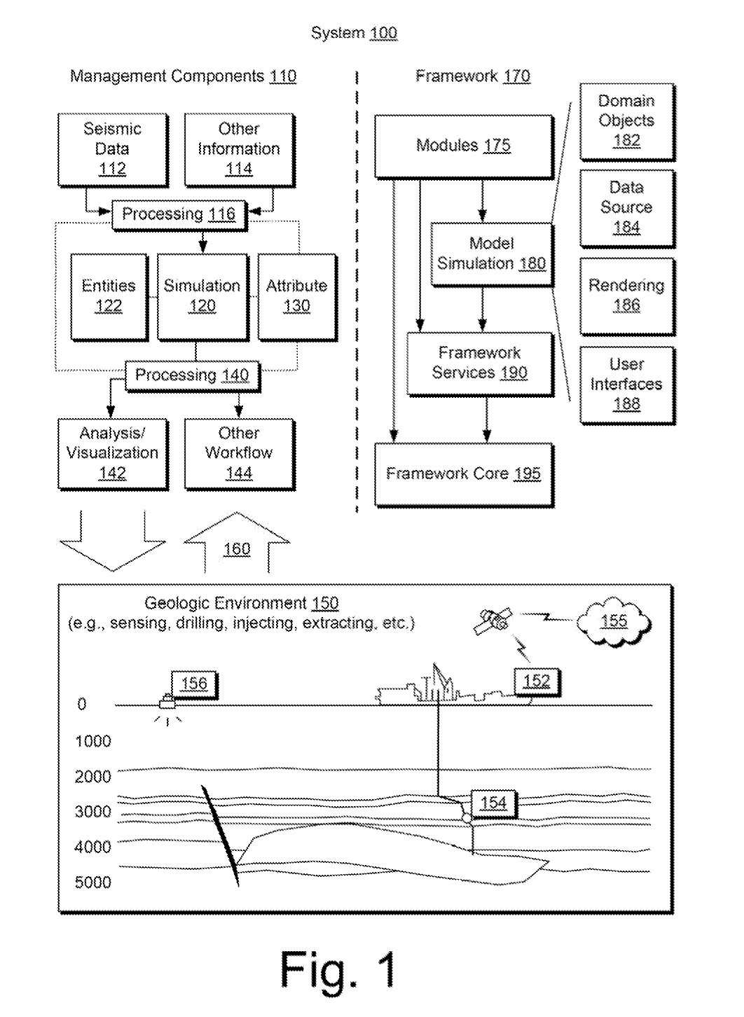

FIG. 1 shows an example of a system 100 that includes various management components 110 to manage various aspects of a geologic environment 150. For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to drill, to assist with resource recovery, etc. Other equipment 156 may be located remote from a well site and include sensing, detecting, emitting or other circuitry. Such equipment may include storage and communication circuitry to store and to communicate data, instructions, etc.

As an example, the system 100 may include a multifunction system such as the InterACT™ system (Schlumberger Limited, Houston, Tex.), which may provide for connectivity, collaboration, information handling, etc. Such a multifunction system may provide for collaboration to facilitate planning and implementation of downhole, desktop or other workflows. Such workflows may include a stimulation operation, a drilling operation, wireline logging, a testing operation, production monitoring, downhole monitoring, etc. (e.g., as workflow steps, workflow processes, workflow algorithms, etc.). Collaboration may occur between any of a variety of parties such as clients, partners, experts, etc. Modules may provide for a variety of graphical user interfaces (e.g., for devices such as desktop terminals or computers, tablets, mobile devices, smart phones, etc.). As an example, a GUI may provide for access to data, navigation, search features, chat capabilities, etc. With respect to the geologic environment 150, a multifunction system may include one or more network interfaces, one or more user interfaces, etc., for the equipment 152, 154, 155 and 156 (e.g., for purposes of monitoring, transmission, collaboration, etc.).

As to the management components 110 of FIG. 1, these may include a seismic data component 112, an information component 114, a pre-simulation processing component 116, a simulation component 120, an attribute component 130, a post-simulation processing component 140, an analysis/visualization component 142 and a workflow component 144. In operation, seismic data and other information provided per the components 112 and 114 may be input to the simulation component 120, optionally with pre-simulation processing via the processing component 116.

As an example, the simulation component 120 may rely on entities 122. Entities 122 may be earth entities and/or geological objects such as wells, surfaces, reservoirs, etc. In the system 100, the entities 122 may include virtual representations of actual physical entities that are reconstructed for purposes of simulation. The entities 122 may be based on data acquired via sensing, observation, etc. (e.g., the seismic data 112 and other information 114).

As an example, the simulation component 120 may rely on a software framework such as an object-based framework. In such a framework, entities may be based on pre-defined classes to facilitate modeling and simulation. A commercially available example of an object-based framework is the MICROSOFT® .NET™ framework (Microsoft Corporation, Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may be a library of attributes. Such processing may occur prior to input to the simulation component 120. Alternatively, or in addition to, the simulation component 120 may perform operations on input information based on one or more attributes specified by the attribute component 130. As an example, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. Additionally, or alternatively, output from the simulation component 120 may be input to one or more other workflows, as indicated by a workflow component 144.

As an example, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

As an example, the management components 110 may include features for geology and geological modeling to generate high-resolution geological models of reservoir structure and stratigraphy (e.g., classification and estimation, facies modeling, well correlation, surface imaging, structural and fault analysis, well path design, data analysis, fracture modeling, workflow editing, uncertainty and optimization modeling, petrophysical modeling, etc.). Particular features may allow for performance of rapid 2D and 3D seismic interpretation, optionally for integration with geological and engineering tools (e.g. classification and estimation, well path design, seismic interpretation, seismic attribute analysis, seismic sampling, seismic volume rendering, geobody extraction, domain conversion, etc.). As to reservoir engineering, for a generated model, one or more features may allow for simulation workflow to perform streamline simulation, reduce uncertainty and assist in future well planning (e.g., uncertainty analysis and optimization workflow, well path design, advanced gridding and upscaling, history match analysis, etc.). The management components 110 may include features for drilling workflows including well path design, drilling visualization, and real-time model updates (e.g., via real-time data links).

As an example, various aspects of the management components 110 may be add-ons or plug-ins that operate according to specifications of a framework environment. For example, a commercially available framework environment marketed as the OCEAN® framework environment (Schlumberger Limited, Houston, Tex.) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. As an example, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may be the commercially available OCEAN® framework where the model simulation layer 180 is the commercially available PETREL® model-centric software package that hosts OCEAN® framework applications.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for various application user interface components.

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model). In such an example, the entity object may include coordinate information, for example, that specifies one or more portions of the well with respect to a coordinate system (e.g., a model coordinate system, etc.).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects (see, e.g., domain objects 182).

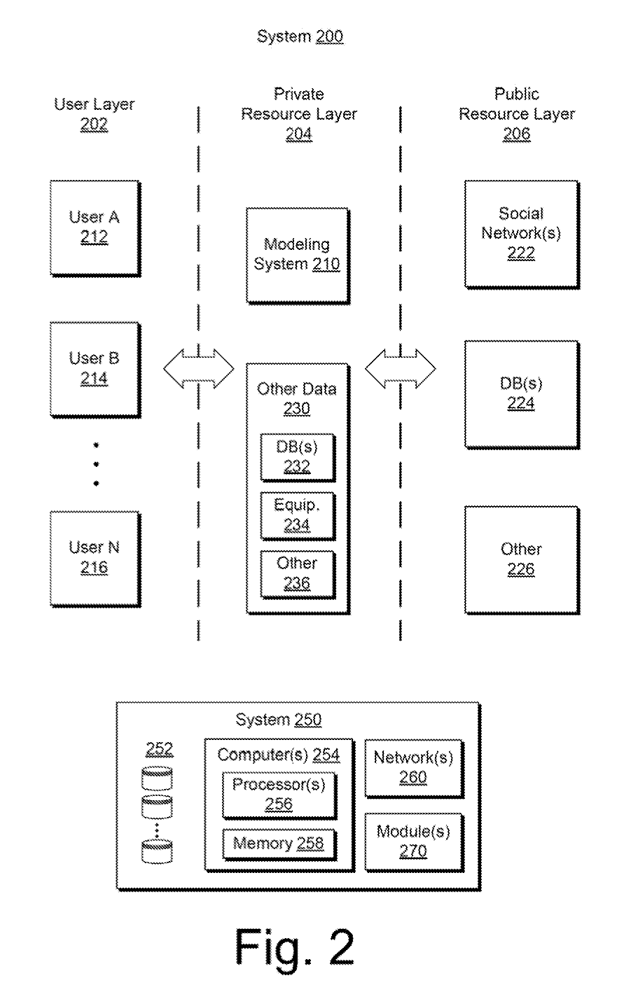

As an example, a system may include a framework configured with one or more modules (e.g., code, plug-ins, APIs, etc.) to leverage any of a variety of resources. FIG. 2 shows an example of a system 200 that includes a user layer 202, a private resource layer 204 and a public resource layer 206 and also an example of a system 250. In the example of FIG. 2, the user layer 202 may include various users 212, 214 and 216 that have permissions or credentials for using the modeling system 210 of the private resource layer 204, and optionally accessing other data 230, which may be considered private or proprietary. For example, the other data 230 may include data in one or more databases 232, equipment data 234, or other data 236. As to the modeling system 210, it may be a model simulation layer such as the layer 180 of the framework 170 and may include one or more of the management components 110 of FIG. 1. As an example, a framework such as the framework 170 may be part of the private resource layer 204 and include private, public or private and public modules configured to interact with the public resource layer 204 and optionally the other data 230 of the private resource layer 204. As to the public resource layer 206, in the example of FIG. 2, it includes one or more social networks 222, one or more databases 224, and one or more other sources of public information 226 (e.g., open to public, which may include subscription sources whether free, fee-based, ad-based, etc.).

Users of a modeling system may benefit from resources that exist in a public resource layer. As an example, consider a user that spends considerable time sitting in front of a display and interacting with one or more applications for monitoring, modeling, etc. In such an example, an application may be knowledge and data driven and the user may experience productivity challenges when knowledge, data or both are not readily at accessible. To help overcome such challenges, one or more components may integrate public source data to assist a user or users. As an example, when a user desires knowledge or data, the user may invoke a component (e.g., during a monitoring session, a drilling session, a modeling session, etc.) where the component responds by rendering relevant public source data to the display.

As shown in FIG. 2, the system 250 can include one or more memory storage devices 252, one or more computers 254, one or more networks 260 and one or more modules 270. As to the one or more computers 254, each computer may include one or more processors (e.g., or cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, a module may include instructions executable by a processor, for example, to instruct a computer, a system, etc. to perform acts (e.g., a method, etc.).

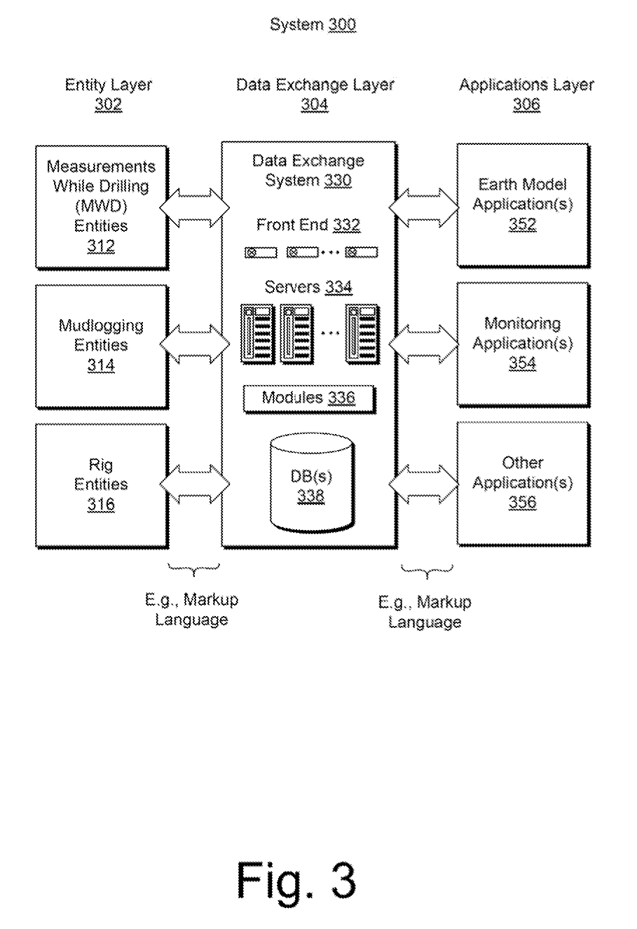

FIG. 3 shows an example of a system 300 that includes an entity layer 302, a data exchange layer 304 and an applications layer 306. The entity layer 302 may include one or more data “measurement while drilling” (MWD) entities 312, one or more mudlogging entities 314, one or more rig entities 316, etc. An entity may be source of data, a requester of data or both. The data exchange layer 304 includes a data exchange system 330, which may include front end equipment 332, one or more servers 334, one or more modules 336 (e.g., executable by a processor of a server, etc.) and one or more databases 338. The applications layer 306 can include one or more applications such as an earth model application 352, a monitoring application 354 or other type of application 356.

In the example of FIG. 3, the data exchange system 330 may include one or more features of the aforementioned InterACT™ system. As an example, data may be exchanged between one layer and another layer using a markup language. An example of a markup language is the WITSML™ markup language (Wellsite Information Transfer Standard Markup Language, Energistics, Sugar Land, Tex.) developed as part of an industry initiative to interfaces for technology and applications (e.g., to monitor wells, manage wells, drilling, fracturing, completions, workovers, etc.). The use of WITSML™ data objects and the data access application programming interface (API) can allow for development of an application that may exchange data with one or more other applications, to combine multiple data sets from different entities (e.g., services, vendors, etc.), for example, into an application (e.g., for analysis, visualization, collaboration, etc.).

In the example of FIG. 3, the earth model application 352 may include one or more features of the aforementioned PETREL® framework. For example, the earth model application 352 may include one or more features of a PETREL® well path design module for well trajectories, platform locations, etc. Such a module may provide for generating trajectories, locations, etc., for a set of reservoir targets in a subterranean formation, for example, to minimize total cost of a drilling program (e.g., via a well cost optimizer module). A well path design module may provide for specifying targets such as “hit” targets (e.g., as data points at one or more depths) where, for example, an optimized well path may be constrained by one or more constraints (e.g., platform, boundaries, dogleg severity, etc.). A module may provide for a Drilling Difficulty Index (DDI), as a metric to characterize a well path, a portion of a subterranean formation, etc.

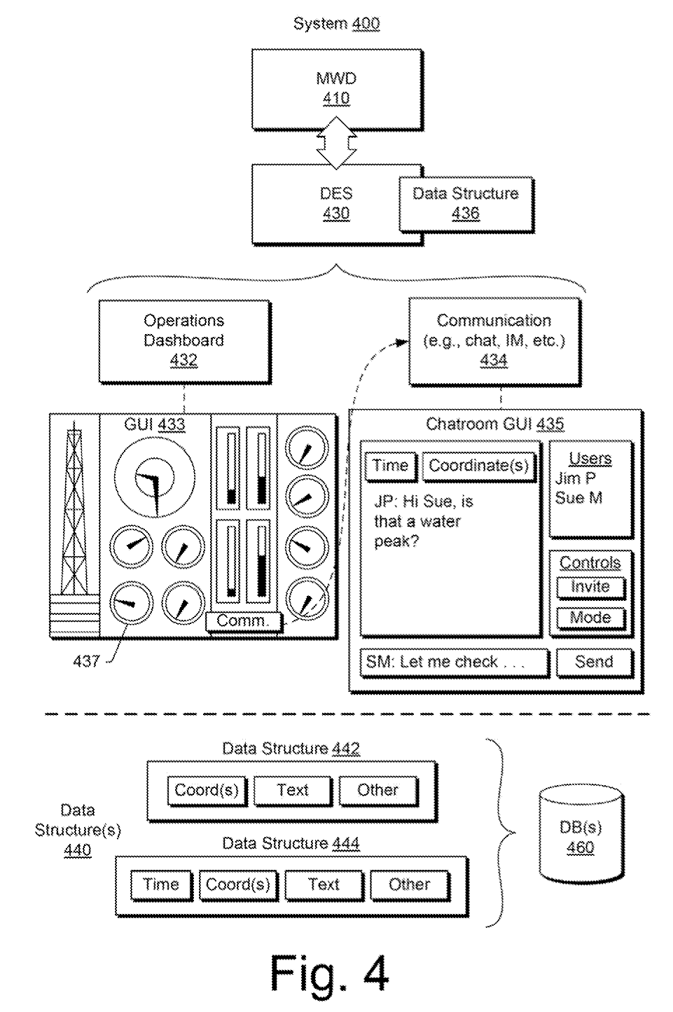

FIG. 4 shows an example of a system 400 that includes a MWD entity 410 and a data exchange system (DES) 430. In the example of FIG. 4, the DES 430 can include an operations dashboard module 432, a communication 434 module (e.g., a chat, IM, etc.) and a data structure module 436.

As an example, the MWD entity 410 can include functionality to package information in a markup language for transmission to the DES 430. Upon receipt by the DES 430, the information provided by the MWD entity 410 can be handled via the operations dashboard module 432 in “real-time” (e.g., delay may be on the order of seconds or less), for example, for purposes of rendering a GUI 433. The information provided by the MWD entity 410 may include information associated with drilling activity at a site or sites and a GUI may provide, for example, multisite visualization of such information.

In the example, of FIG. 4, the GUI 433 associated with the operations dashboard module 432 may be rendered to a display, projected to a screen, etc., in the form that allows for user interaction. For example, one or more input devices (e.g., mouse, touchscreen, pointer, microphone, etc.) may allow a user to initiate a chat session via a command entered via a graphical control (e.g., “Comm.”) of the GUI 433 or another other control associated with the DES 430. Referring to the example of FIG. 3, as noted, the DES 330 may be server-based and accessible via a network such as the Internet or other network (e.g., cellular, satellite, etc.). Thus, in the foregoing example, input may occur via microphone, keypad, or touch screen of a smart phone where the operations dashboard module 432 provides information for rendering the GUI 433 to a display of the smart phone.

As an example, consider a user viewing, on a tablet or other local device executing a browser application, the GUI 433 according to browser instructions and information (e.g., in a markup language) transmitted by the DES 430. Upon review of information in the GUI 433, the user may wish to collaborate with another party. To do so, the user may enter a command (e.g., touchscreen, keypad, voice, etc.) that, upon receipt by the DES 430, instructs the DES 430 to initiate chat functionality and to transmit browser application instructions for rendering of a chatroom GUI 435. In turn, the user may select a control of the GUI 435 to invite one or more parties to participate in a chat session (e.g., “Invite”). In this example, participation in the chat session may occur via any of a variety of communication modes (e.g., voice, text, video, etc.).

As shown in FIG. 4, the chatroom GUI 435 includes two parties “Jim P” or “JP” and “Sue M” or “SM”. In a text entry field, a party to the chat session may enter text and hit a send control button. For example, JP has sent the text “Hi Sue, is that a water peak?” In response, SM has begun entering text in the text field “Let me check . . . .”

In the example of FIG. 4, the data structure module 436 of the DES 430 provides for data structuring functionality to structure entity information and communication information. For example, entity information may be information associated with on-site activity. Thus, for example, the MWD entity 410 may provide information that can be structured with respect to communication information associated with communication activity. In the example of FIG. 4, the communication information in the chatroom GUI 435 is in the “context” of the MWD entity information, some of which may be represented by the GUI 433.

As to data structures 440, FIG. 4 shows two examples, data structure 442 and data structure 444, which may be suitable for storage in one or more databases 460. In the example of FIG. 4, the data structure module 436 may determine which data structure to use, for example, depending on context, entity, communication mode, etc. For example, where communication includes voice, a data structure may include an audio file or a link to an audio file (e.g., optionally compressed), where communication includes video, a data structure may include a video file or a link to a video file (e.g., optionally compressed), where communication includes sharing of an application (e.g., a modeling application), a data structure may include a sequence of instructions, screen shots, etc., that may have occurred during sharing of the application, etc.

Referring to the examples of FIG. 4, the data structure 442 includes a coordinate field, a text field and optionally another field while the data structure 444 includes also includes a time field. As to coordinate, time or coordinate and time, such information can provide for linking information or otherwise associating information. For example, a drilling operation may provide depth at a time whereas a communication session may provide a time. In the context of a project model, actual time (e.g., universal time) of communication information may be of less value than depth of a drill bit at the time of the communication information. The latter may provide for supplementation of the project model (e.g., at that depth) with quantitative communicated information, qualitative communicated information, etc.

As an example, the data structure 442 may include a coordinate field, a text field and a site identification code field and include information such as: 1523.23; water peak; 12344. As an example, the data structure 444 may include a time field (e.g., for a UTC per ISO 8601), a coordinate field, a text field and a site identification code field (e.g., to identify a well) and include information such as: 20XX-01-XXT21:34 Z; 1523.23; water peak; 12344. In the foregoing examples, the site identification code information may provide for linking the text to an earth model application project where the coordinate (e.g., depth) allows for connection to a physical location within the model application project. As an example, a coordinate field may accommodate coordinates, for example, one-dimensional coordinates, two-dimensional coordinates, three-dimensional coordinates, etc.

As an example, a seismic survey may be conducted using shots. In such an example, individual shots may be associated with at least one coordinate. As an example, a shot may be associated with a number that corresponds to a depth. In such an example, the number may be considered a depth (e.g., a coordinate).

As an example, a shot depth (e.g., or a shot number) may specify a location of a seismic source (e.g., an explosive or other source) of a subterranean formation. As an example, a seismic survey may be performed by drilling holes at shotpoints and placing explosive in the holes. As an example, shotholes may be more than about 50 m (e.g., about 164 ft) deep; noting that depths of about 6 m to about 30 m (e.g., about 20 ft to about 98 ft) may be used, for example, depending on various conditions. As an example, a seismic survey may be performed using surface-based sources. For example, vibrators, shots from air shooting, etc. may be used, which may be associated with one or more coordinates of the Earth's surface (e.g., a surface of a subterranean formation).

As an example, shot points may specify locations or stations at which a seismic source is activated. As an example, a coordinate may specify a seismic line, a portion of a seismic line or a point on a seismic line. As an example, a seismic line may be a line specified as part of a seismic survey, for example, a crossline may be perpendicular to a direction in which seismic data are acquired. In such an example, the direction may be an inline or inline direction.

As an example, the aforementioned InterACT™ system includes communication functionality for a chatroom. For example, a GUI of the InterACT™ system provides various fields to setup a chatroom such as name (e.g., “drilling chatroom”), description (e.g., “chatroom with client”), activity (e.g., a dropdown menu), and category (e.g., a dropdown menu). Such a GUI also includes a check box control for display of a coordinate(s) (e.g., for a drilling operation) and a dropdown menu for units (e.g., meters or feet).

In the example of FIG. 4, functionality of the DES 430 may allow a user to tag information for inclusion in a communication and optionally for inclusion in a data structure. For example, the user JP may select one of the graphics in the GUI 433 via a command (e.g., voice, touch, mouse, etc.) where upon selection information associated with that graphic is included or linked to a communication such as the communication in the chatroom GUI 435. In such a manner, for the example of FIG. 4, the user does not have to retype a measurement reading, etc., in the text field. As an example, the user may select the gauge graphic 437 of the GUI 433 and the information associated with the graphic 437 may be included in one or more of the data structures 440 (e.g., other field). Such functionality allows a user to readily include information that can enhance context for the ongoing communication as well as for an audit, future assessment, etc.

Entities such as exploration and production companies (e.g., E&P companies) or other companies may have access to massive volumes of private, commercial and public information from a diverse range of locations, sources, etc. The system 400 of FIG. 4 can provide information in a structured form that places such information in context, which may assist with placing other information in context as well.

As an example, a drilling process may include managing drilling fluid (e.g., drilling mud). Drilling fluid may include a number of liquid fluids, gaseous fluids and/or mixtures of fluids and solids (e.g., as solid suspensions, mixtures and emulsions of liquids, gases and solids). Drilling fluid may be used in an operation to drill a borehole into earth. As an example, drilling fluid may be classified according to a classification scheme, for example, based on mud composition and by function and performance of the fluid: (1) water-base, (2) non-water-base and (3) gaseous (pneumatic). In such an example, each class (e.g., category) may include one or more subclasses (e.g., subcategories).

As an example, a process may account for fluid penetration and/or other drilling operation effects on wellbore instability. For example, a process may include a model that may include features to describe pressure changes on a weak plane (fractures) to account fluid penetration effect, a model may account for one or more of liquefaction (liquification), surface tension effects, etc. As an example, a model may account for one or more of vibration, settling, drilling fluid/mud, surge, swab, vibrator sweep, etc. As an example, a process may include searching information (e.g., tagged information, etc.) and optionally inputting such information into a model for purposes of informing the process, for example, making decisions, optionally in near real-time. For example, where the process is a drilling process, data and one or more coordinates associated with the data may be provided to an indexing module while, for example, searches are made using a search index or search indexes (e.g., optionally based on one or more process parameter values, data, one or more coordinates associated with the drilling process, etc.). In such an example, a coordinate or coordinates may be associated with an application that may include a model of a subterranean environment in which the drilling is occurring. As an example, search results may include one or more communications, for example, that may be associated with a coordinate, coordinates, a process, a model, a well, a borehole, a fault, a fracture, a structure, a layer, stratigraphy, lithology, etc.

As an example, drilling may be considered an exploratory process in that a drill bit may drill to a location that has not previously been explored (e.g., a “new” location). In such an example, conditions at that location may be inferred via previously acquired information, optionally accessed via data acquired during the drilling process. As an example, one or more models may be provided that can receive information and output assessments, estimates, etc. as to conditions at a location, for example, to guide a process (e.g., a drilling process).

As an example, a method may include recommending a change in mud-weight, an optimization of well trajectory (e.g., deviation, azimuth, etc.), a change in drilling operation (e.g., to minimize pressure fluctuation when tripping in/out of the whole), a hole clean-up operation, an optimized cementing or completion operation or production schedule, etc.

As an example, a process may be a hydraulic fracturing process that includes injecting material into a well, which may be in an environment where interactions may occur with one or more natural fractures. In such an example, a search may be performed to uncover information about one or more natural fractures (e.g., optionally modeled using an application that includes a model of the environment). For example, consider a drilling process that generates one or more coordinates, optionally with other information, that may be used to perform a search as to natural fractures. In such an example, a feedback loop may inform the drilling process, for example, to direct a drill bit in a direction favorable to leveraging one or more natural fractures for purposes of hydraulic fracturing (e.g., to increase drainage from a drainage region). For example, such a process may aim to form an angle between an axis of a borehole and a natural fracture plane, which may consider the likely angle of a plane of a hydraulic fracture (e.g., to form a pattern or patterns to enhance drainage, etc.). In such an example, a model of the environment being drilled (e.g., or fractured) may be rendered to a display, optionally in conjunction with information that is being exchanged (e.g., via inputs, searches, communications, etc.).

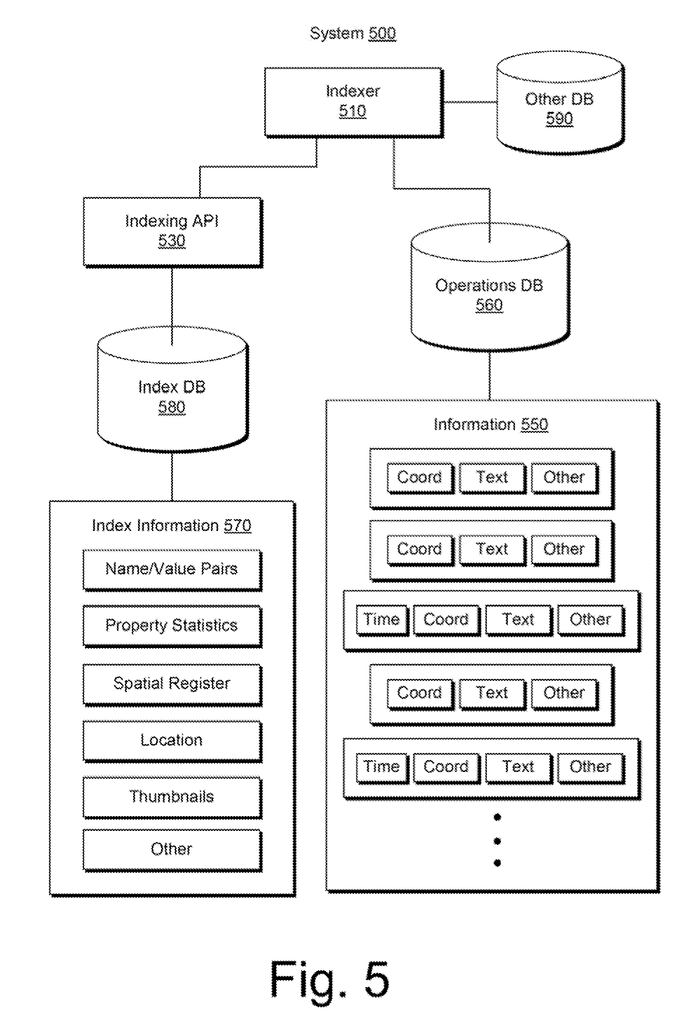

FIG. 5 shows an example of a system 500 for indexing information, for example, to facilitate search of such information. As an example, the system 500 may include features of the aforementioned STUDIO E&P™ knowledge environment such as the STUDIO FIND™ search functionality, which can provide an index(es) for content, and the STUDIO ANNOTATE™ annotation functionality, which can provide for tagging of information (e.g., attributes for contributors to a G&G processes, notes on different decisions, etc.). Annotations may include tags that “attach” information, for example, in the form of one or more links to documents, information on well completions, information on additives used, information on proppants used (e.g., for fracturing, etc.), diagrams, photographs, downhole measurements, equipment used, etc. Referring again to the system 400 of FIG. 4, the one or more data structures 440 may be formed by an annotation process that includes filling one or more data structure fields with information (e.g., text, data, a link, etc.).

The system 500 of the example of FIG. 5 includes an indexer 510 to index data, which may be, for example, retrieved from one or more databases 560 and 590. The database 560 may be an operations database that includes one or more data structures that include information, for example, as described with respect to the data structures 440 of FIG. 4. The database 590 may include any of a variety of information (e.g., private, public, etc.). An index database 580 includes information 570, which may include application project, name/value pairs, property statistics, spatial register, location, thumbnails, or other information. In the example of FIG. 5, the index database 580 may be project centric (e.g., for projects of a modeling application or applications).

In the example of FIG. 5, an application programming interface (API) 530 may allow the indexer 510 to access and optionally retrieve information 570 in the index database 580. In turn, the indexer 510 can access and optionally retrieve information 550 in the operations database 550. Logic within the indexer 510 can provide for associating the information 550 with index information 570. The indexer 510 may generate an index and store the index, for example, in a manner akin to a search engine that indexes websites (e.g., where the indexer 510 collects, parses, and stores data to facilitate fast and accurate information retrieval).

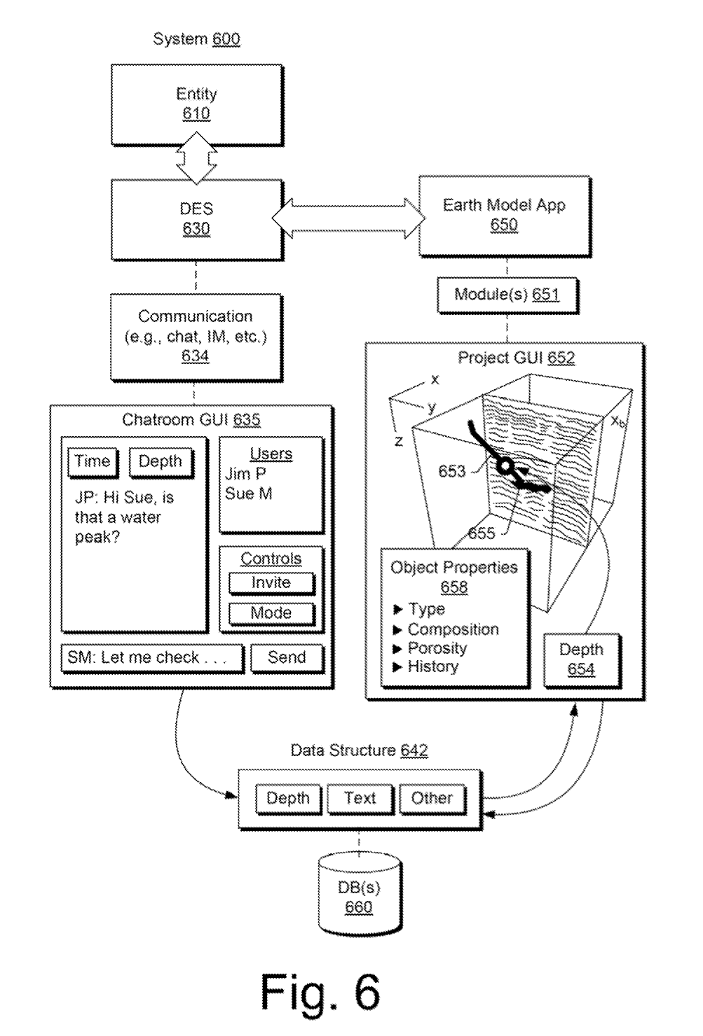

FIG. 6 shows an example of a system 600 that includes an entity 610 (see, e.g., entities of the entity layer 302 of FIG. 3), a data exchange system (DES) 630 and an earth model application 650. In the example of FIG. 6, the DES 630 includes a communication module 634 that may provide instructions and information for rendering a chatroom GUI 635 and the earth model application 650 includes one or more modules 651 that may provide instructions and information for rendering a project GUI 652.

In the example of FIG. 6, the project GUI 652 includes a well trajectory graphic 653 and a reservoir graphic 655 that may be represented as objects within the earth model application 650 where such objects include object properties 658 (e.g., information to define characteristics of the objects). As an example, the DES 630 can provide for forming a data structure 642 that includes depth information for a well (e.g., coordinate information) where, for example, information associated with the depth information (e.g., coordinate information) may be represented or otherwise be associated with the project of the project GUI 652. For example, the data structure 642 may exist in one or more databases 660 accessible by the earth model application 650 where depth information 654 (e.g., coordinate information) may be parsed from the data structure 642 by the earth model application 650. In turn, the one or more modules 651 of the earth model application 650 may provide instructions and information for rendering a graphic at a depth based on the depth information 654 (e.g., coordinate information) in the data structure 642 (see, e.g., open circle along the well trajectory graphic 653). Such a graphic may be selectable by a command input by a user, for example, to display text from a communication session such as the text in the chatroom GUI 635. For example, upon selection of the graphic, a window may appear that displays text from the communication session concerning the user “JP” query as to a water peak at the particular depth (e.g., coordinate or coordinates). Where a communication session includes audio, selection of the graphic may commence a media player for playing of a media file associated with the data structure 642; noting that text-to-speech rendering may be provided as an option for text, that an image viewer may be provided as an option for an image associated with the data structure, that a video player may be provided as an option for video associated with the data structure, etc.

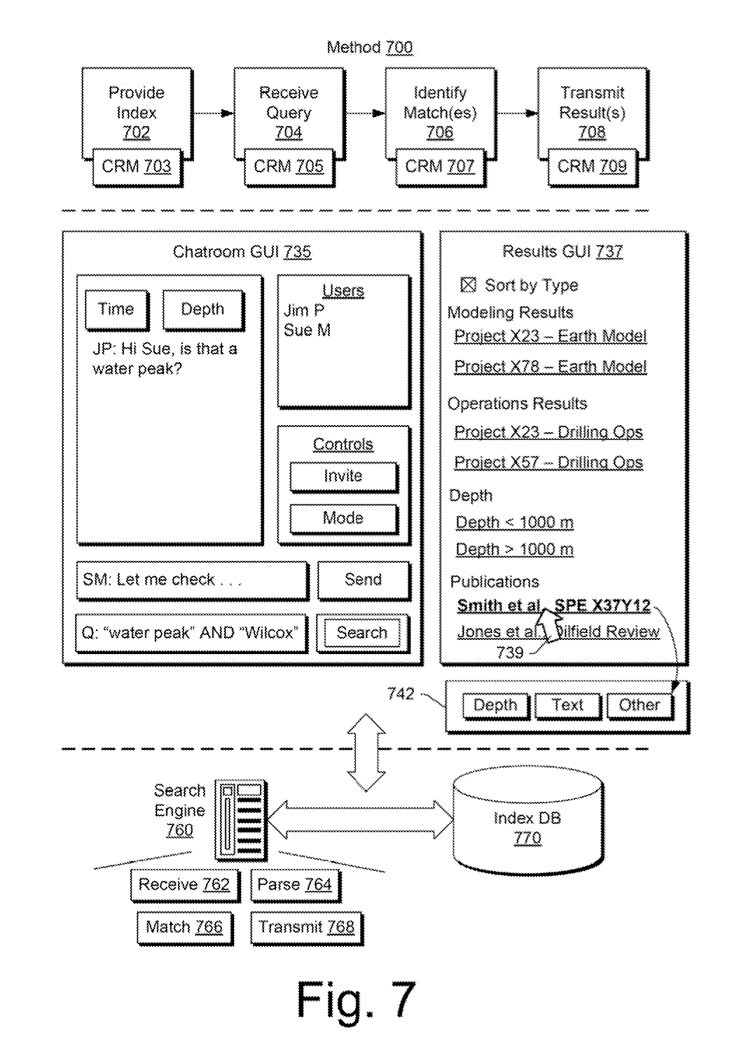

FIG. 7 shows an example of a method 700 along with an example of a chatroom GUI 735, a results GUI 737, a search engine 760 and an index database 770. In the method 700, a provision block 702 provides an index, a reception block 704 receives a query, an identification block 706 identifies one or more matches for the query and a transmit block 708 transmits at least one of the one or more matches. As an example, the index database 770 may provide the index, the chatroom GUI 735 may include a query field for entry of a query and a control for transmission of the query to the search engine 760 (e.g., a server or other computing device or system) where the search engine 760 may include a reception module 762 to receive a query, a parse module 764 to parse the query, a match module 766 to search for one or more matches (e.g., to information, terms, etc., included in the query) and a transmission module 768 to transmit at least one of the one or more matches for presentation as results in the results GUI 737.

In the example of FIG. 7, one of the users listed in the chatroom GUI 735 (e.g., a party participating in the communication) enters in the query field search terms “water peak” and “Wilcox” (e.g., Wilcox formation) and in response to submission of the query, the search engine 760 returns results displayed in the results GUI 737. As shown, the results GUI 737 may include one or more sorting or filtering options to be applied to the results (e.g., “sort by type”). In the example of FIG. 7, a sort by type of result graphic control is selected and results are sorted into the categories: modeling results, operations results, coordinate(s) (e.g. depth, etc.) and publications. The results GUI 737 shows results for each category, which may be links (e.g., uniform resource locators, “URL”s, etc.) for expanding a category or accessing documents, a webpage, etc., which may be private or publicly available.

In the example of FIG. 7, one of the users (e.g., participants listed in the chatroom GUI 735) may select one of the results displayed by the results GUI 737. For example, a cursor 739 is shown as selecting a publication to Smith et al. As this activity occurs within the context of a communication session, it may be included in a data structure 742 and associated with one or more of depth (e.g., coordinate(s)), time, site location, well, etc.

In the example of FIG. 7, the chatroom GUI 735 and the results GUI 737 may be provided as part of a DES, part of an earth modeling application, or part of another application. Where the chatroom GUI 735 and the results GUI 737 are included in a DES, the data structure 742 may become associated with, for example, an earth modeling application. Referring again to the example project GUI 652 of FIG. 6, the graphic located along the well trajectory graphic 653 may upon its selection present the link to the publication to Smith et al. or access the publication and present it in a new window (e.g., a pdf reader window). In an example where the chatroom GUI 735 and the results GUI 737 are included in an earth modeling application, the data structure 742 may become associated with, for example, a DES such as the DES 330, which may be operable during one or more field operations (see, e.g., entities of the entity layer 302).

The method 700 is shown in FIG. 7 in association with various computer-readable media (CRM) blocks 703, 705, 707, and 709. Such blocks generally include instructions suitable for execution by one or more processors (or cores) to instruct a computing device or system to perform one or more actions. While various blocks are shown, a single medium may be configured with instructions to allow for, at least in part, performance of various actions of the method 700.

As an example, one or more computer-readable media can include computer-executable instructions to instruct a computer to: provide a search index that includes indexed operations information for an operation in a well in a subterranean formation, coordinate information for a depth in the well, and communications information associated with the well in the subterranean formation for a communication occurring at a time of an operation performed at the depth in the well; receive a query; identify one or more matches for the query using the search index; and transmit one or more results responsive to the query based at least in part on the one or more matches.

As an example, instructions may also be provided to instruct a computer to update the search index based at least in part on operations information for an operation in another well in the subterranean formation, coordinate information for a depth in the other well, and communications information associated with the other well in the subterranean formation for a communication occurring at a time of an operation performed at the depth in the other well. Accordingly, a search index may include information for a plurality of wells, which may be in the same subterranean formation or optionally in one or more other subterranean formations.

As an example, instructions may be provided to instruct a computer to parse a query where the query includes search criteria. As an example, instructions may be provided to instruct a computer to identify one or more matches based at least in part on a term of a query and a term in indexed communications information.

As mentioned, results may be in the form of resource locators such as URLs, thus, instructions may be provided to instruct a computer to transmit one or more results as URLs.

One or more scenarios may exist for a communication session, which may be initiated within any of an applications layer, a data exchange layer, an entity layer, etc., where a data exchange layer can manage associations between communicated information and other information and optionally provide search functionality based at least in part on such associations. Such search functionality may be provided during a communication session or after a communication session. As to operations, modeling, etc., for a subterranean formation, coordinate information may allow for associating information. As explained in various examples, operations such as drilling can provide coordinate information and modeling such as earth modeling can provide a model that includes coordinate information. Thus, coordinate information for an operation being executed on a subterranean formation can be used to associate the operation and team communications to a model of the subterranean formation and coordinate information for a model of a subterranean formation can be used to associate the model and team communications to an operation executed, being executed, to be executed or planned, being planned or to be planned.

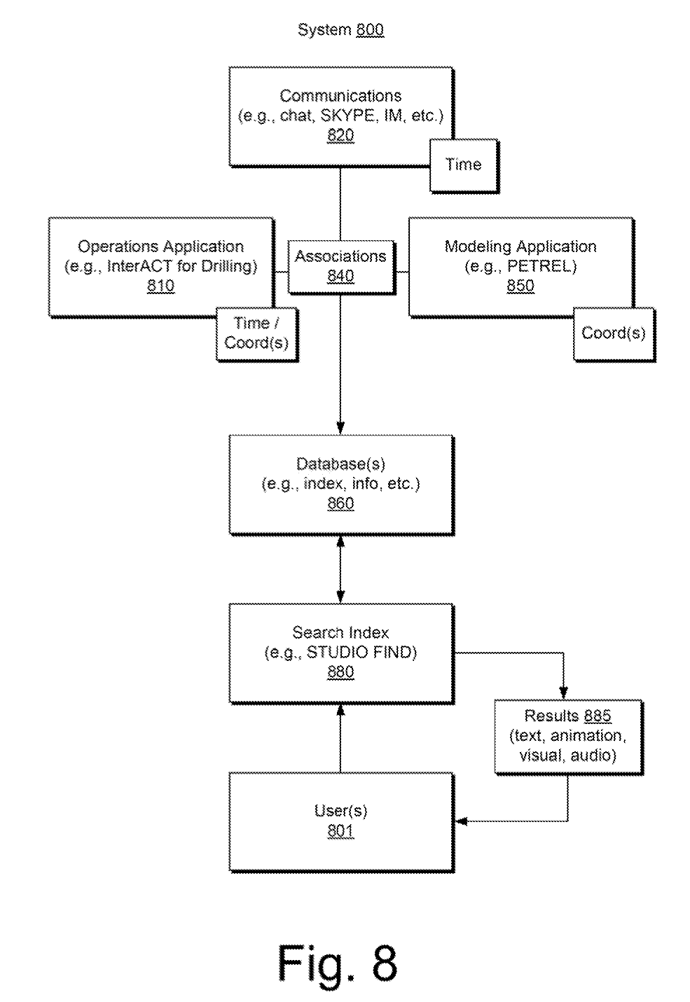

FIG. 8 shows an example of a system 800 that includes an operations application module 810, a communications module 820, an associations module 840, a modeling application module 850, a database module 860, and a search index module 880.

A user module 801 provides for one or more users to enter one or more search terms, criteria, etc., to the search index module 880 where the index search module 880 can return one or more results per a results module 885 (e.g., or an indication that no results match the search). As to the operations application module 810, it may provide one or more of time information and coordinate information, as to the communications module 820, it may provide time information, and as to the modeling application module 850, it may provide coordinate information. In the example of FIG. 8, associations may be made by the associations module 840 based on such types of information and associated information may be stored in one or more databases per the database module 860. Such information may be indexed for purposes of searching per the search index module 880. As additional information is generated in one or more of the operations application module 810, the communications module 820, the modeling application module 850, the search index module 880 may perform additional indexing to update an index to dynamically enrich the search capabilities.

In the example of FIG. 8, an index approach to search can enhance performance in finding relevant documents responsive to a query. The search index module 880 may include search engine functionality for indexing wherein indexing may include collecting, parsing, and storing data to facilitate information retrieval.

As an example, a system can include an operations module to acquire operations information for an operation associated with a coordinate of a subterranean formation; a communications module to acquire communications information for a communication associated with a time; an association module to associate the coordinate of the subterranean formation and the time of the communication; and a search index module to index the acquired operations information and communications information and the coordinate of the subterranean formation or the time of the communication. In such a system, the search index module to index may include indexing to index the coordinate of the subterranean formation and the time of the communication. As an example, a system may include a structure module to form a data structure that includes a coordinate field for the coordinate (e.g., coordinate information, which may include one or more coordinates), a time field for the time or a coordinate field for the coordinate (e.g., coordinate information, which may include one or more coordinates) and a time field for the time. Such a module may optionally be part of the associations module 840. As an example, a data structure can include a communications information field for communications information, an operations information field for operations information, etc.

As an example, a system can include a processor; memory operatively coupled to the processor; and modules stored in the memory that include processor-executable instructions, for example, to instruct the system to perform acts (e.g., a method, etc.). In such an example, the modules can include an operations module to acquire operations information for an operation associated with a coordinate of a subterranean formation (e.g., as represented in a coordinate system of the subterranean formation, which may be a coordinate system of a model); a communications module to acquire communications information for a communication associated with a time; an association module to associate the coordinate of the subterranean formation and the time of the communication; and a search index module to index the acquired operations information and communications information and the coordinate of the subterranean formation or the time of the communication.

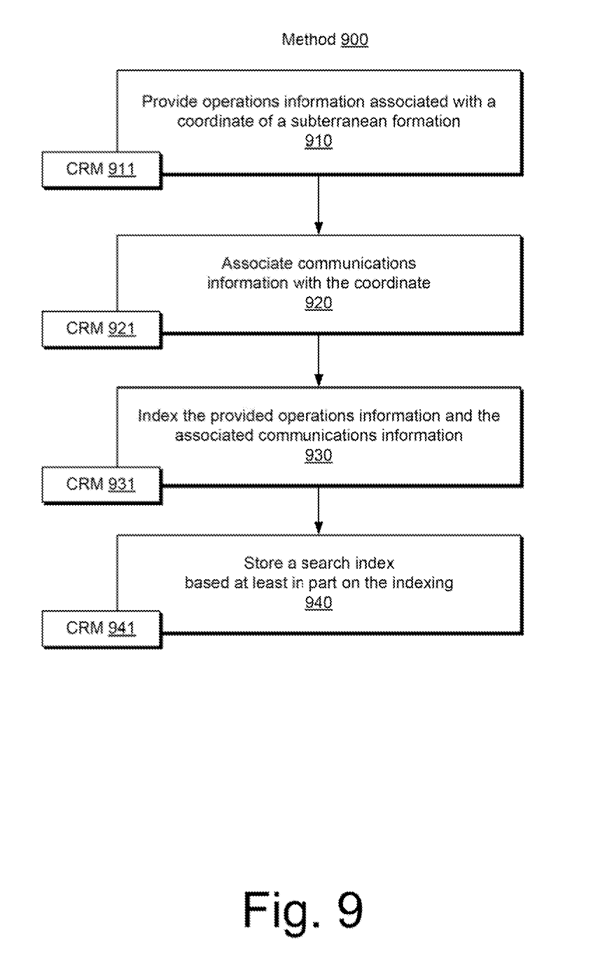

FIG. 9 shows an example of a method 900 that includes a provision block 910 for providing operations information associated with a coordinate of a subterranean formation, an association block 920 for associating communications information with the coordinate; and index block 930 for indexing the provided operations information and the associated communications information; and a storage block 940 for storing a search index based at least in part on the indexing. In such a method, communications information can include communications information acquired during an operation at the coordinate in the subterranean formation (e.g., a coordinate may be a depth, which may be a well depth). As an example, communications information can include one or more text communications or other information. As to associating per the association block 920, it may include forming a data structure that includes a coordinate field and a communications information field. As an example, operations information associated with a coordinate of the subterranean formation can include operations information for a drilling operation (e.g., optionally at that coordinate, for example, a depth of a drill bit in the subterranean formation).

As an example, where modeling information exists, the method 900 may include associating modeling information with the coordinate, indexing the modeling information and storing a search index based at least in part on the indexing of the modeling information. In such an example, the modeling information can include modeling information for a model of the subterranean formation.

The method 900 is shown in FIG. 9 in association with various computer-readable media (CRM) blocks 911, 921, 931, and 941. Such blocks generally include instructions suitable for execution by one or more processors (or cores) to instruct a computing device or system to perform one or more actions. While various blocks are shown, a single medium may be configured with instructions to allow for, at least in part, performance of various actions of the method 900.

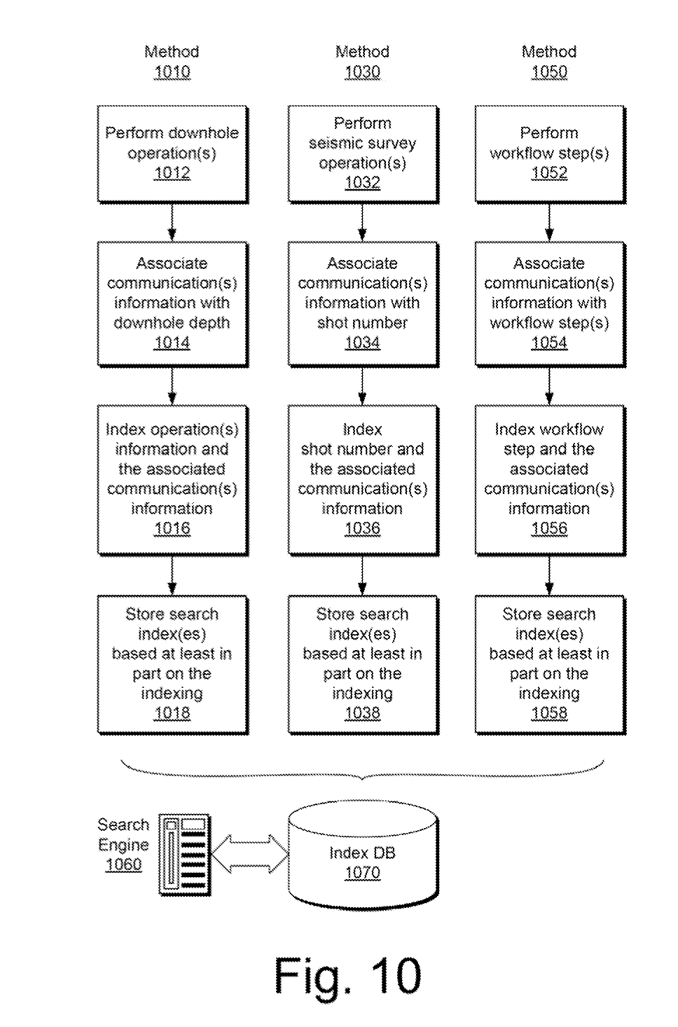

FIG. 10 shows examples of methods 1010, 1030 and 1050, which may optionally be performed individually, collectively, selectively, simultaneously, etc. As shown in FIG. 10, the method 1010 includes a performance block 1012 for performing one or more downhole operations (e.g., by inserting a tool, tool string, etc. into a hole or to make or enlarge a hole), an association block 1014 for associating communication(s) information with downhole depth (e.g., as operation(s) information ascertained during a performed downhole operation, etc.), an index block 1016 for indexing the operation(s) information and the associated communication(s) information, and a storage block 1018 for storing one or more search indexes based at least in part on the indexing. As an example, a downhole operation may be a drilling operation that includes a drill string and optionally one or more tools (e.g., for sensing, etc.). In such an example, downhole depth may be an in-hole depth or a depth along an axis (e.g., in a direction normal to a surface). In such an example, a depth may be a depth in a layer of a subterranean basin, for example, to be modeled or modeled in an earth model (e.g., as in a framework such as the PETREL® seismic-to-simulation framework). While depth is mentioned in the foregoing example, one or more other coordinates may be provided, for example, alternatively or additionally.

As shown in FIG. 10, the method 1030 includes a performance block 1032 for performing one or more seismic survey operations, an association block 1034 for associating communication(s) information with a shot number or a proxy thereof (e.g., as operation(s) information ascertained during a performed seismic survey, etc.), an index block 1036 for indexing the operation(s) information and the associated communication(s) information, and a storage block 1038 for storing one or more search indexes based at least in part on the indexing.

As an example, a shot number can correspond to an activation of a source to emit seismic energy, for example, as in a series of activations (e.g., optionally parallel activations). In such an example, seismic energy incident on a receiver may be recorded, for example, for a pre-determined period from a start of a sweep time of the source where the time from an end of the sweep time to an end of a recording period may be referred to as a listening time. Data acquired at a receiver from the start of the sweep time to the end of the listening time may be operational information associated with a shot number.

As an example, acquisition, processing, and interpretation of repeated seismic surveys over a field (e.g., a producing hydrocarbon field) may be performed to determine changes in one or more parameters with respect to time (e.g., as a result of hydrocarbon production, injection of water or gas, etc.). In such an example, a time-lapse difference dataset (e.g., seismic data from Survey 1 subtracted from seismic data from Survey 2) may be constructed, for example, that includes communication information as associated multiple surveys (e.g., indexed based on one or more factors germane to an understanding or characterization of the field). While a time-lapse difference of data may be close to zero, indicative of little or no change to the field, communication information may indicate that one or more conditions have changed (e.g., qualitative information not captured by the acquired data of the surveys). Accordingly, communication information (e.g., indexed to a survey parameter, data, etc.) may provide for a determination as to one or more next steps, assessments of a field, etc.

As shown in FIG. 10, the method 1050 includes a performance block 1052 for performing one or more workflow steps, an association block 1054 for associating communication(s) information with one or more workflow steps (e.g., as operation(s) information ascertained during a performed workflow, etc.), an index block 1056 for indexing the operation(s) information and the associated communication(s) information, and a storage block 1058 for storing one or more search indexes based at least in part on the indexing. As an example, one or more steps in a workflow may be performed, for example, where information is exchanged by individuals during a horizon interpretation or other workflow process (e.g., fault interpretation, model building, simulation, etc.). In such an example, the information may be communication information associated with communications that occur during performance of one or more types of workflow steps. Where indexing occurs and an index is stored, an individual may perform a search using a search engine to uncover one or more communications as made during that individual's performance and/or another's performance of a particular workflow step (or workflow steps).

As an example, a training module may be developed based on an experienced user making communications during a workflow that includes multiple workflow steps. Such communications may be indexed and stored to allow a less experienced user to access the communications while or before performing that workflow (e.g., or a workflow that includes one or more common workflow steps).

As an example, a communication may be between an expert team (e.g., at a headquarter facility) and an asset team (e.g., in the field). As an example, an operation may be an interpretation to a simulation workflow as a part of a reservoir assessment (e.g., where one or more decisions are to be made as to development of the reservoir, economics of the reservoir, commonalities of the reservoir with another reservoir, etc.).

As shown in FIG. 10, a search engine 1060 may be provided that can search an index or indexes in an index database 1070. In the example of FIG. 10, one or more of the storage blocks 1018, 1038 and 1058 may include storing one or more indexes in the index database 1070. As an example, the search engine 1060 may include user selectable options (e.g., fields, etc.) to limit a search to one or more indexes in the index database 1070. For example, a user may input an indicator in a field of a graphical user interface of a search engine (e.g., front end) to include or exclude a search to downhole operation(s), seismic survey operation(s) and/or workflow step(s).

One or more of the methods 1010, 1030 and 1050 may optionally be implemented in part via instructions suitable for execution by one or more processors (or cores) to instruct a computing device or system to perform one or more actions. As an example, a single medium may be configured with instructions to allow for, at least in part, performance of various actions of one or more of the methods 1010, 1030, and 1050 of FIG. 10.

As an example, one or more computer-readable media may include computer-executable instructions to instruct a computing system to output information for controlling a process. For example, such instructions may provide for output to sensing process, an injection process, drilling process, an extraction process, etc.

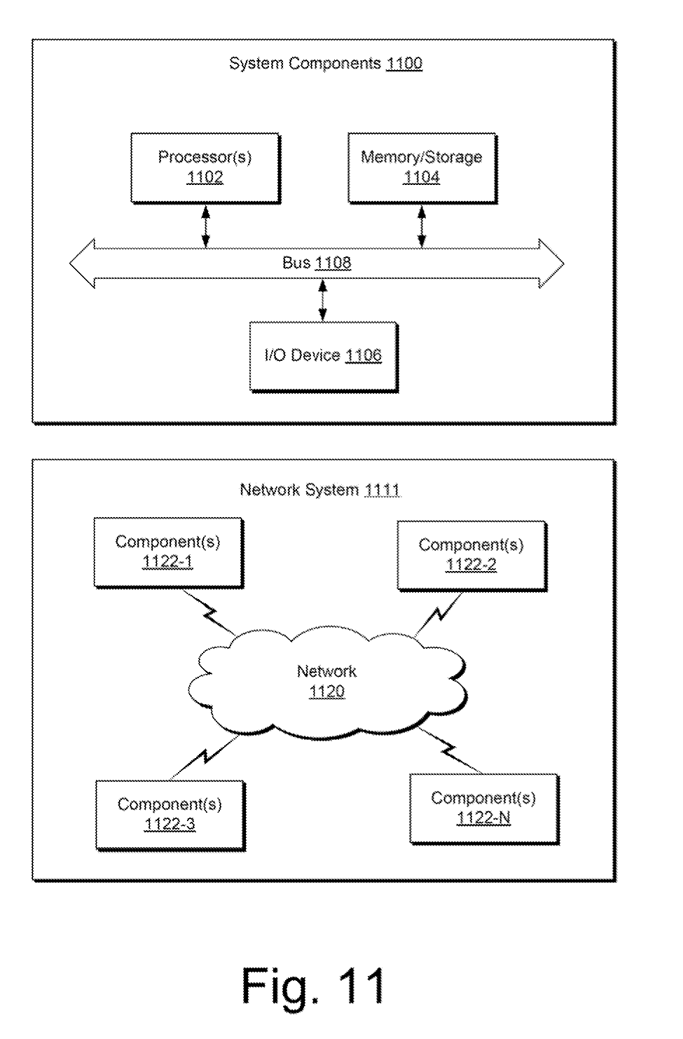

FIG. 11 shows components of a computing system 1100 and a networked system 1110. The system 1100 includes one or more processors 1102, memory and/or storage components 1104, one or more input and/or output devices 1106 and a bus 1108. As an example, instructions may be stored in one or more computer-readable media (e.g., memory/storage components 1104). Such instructions may be read by one or more processors (e.g., the processor(s) 1102) via a communication bus (e.g., the bus 1108), which may be wired or wireless. The one or more processors may execute such instructions to implement (wholly or in part) one or more attributes (e.g., as part of a method). A user may view output from and interact with a process via an I/O device (e.g., the device 1106). As an example, a computer-readable medium may be a storage component such as a physical memory storage device, for example, a chip, a chip on a package, a memory card, etc.

As an example, components may be distributed, such as in the network system 1110. The network system 1110 includes components 1122-1, 1122-2, 1122-3, . . . 1122-N. For example, the components 1122-1 may include the processor(s) 1102 while the component(s) 1122-3 may include memory accessible by the processor(s) 1102. Further, the component(s) 1102-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

### CONCLUSION

Although a few example embodiments have been described in detail above, those skilled in the art will readily appreciate that modifications are possible in the example embodiments. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be functionally equivalent structures. It is the express intention of the applicant not to invoke 35 U.S.C. §112, paragraph 6 for any limitations of any of the claims herein, except for those in which the claim expressly uses the words “means for” together with an associated function. As such, the foregoing description is not intended to be limited to the particulars disclosed herein; rather it extends to all functionally equivalent structures, methods and uses, such a are within the scope of the following claims.

1. A method comprising:
providing operations information associated with a coordinate of a subterranean formation;
associating communications information with the coordinate;
indexing the provided operations information and the associated communications information; and
storing a search index based at least in part on the indexing.

2. The method of claim 1 wherein the communications information comprises communications information acquired during an operation at the coordinate of the subterranean formation.

3. The method of claim 1 wherein the communications information comprises one or more text communications.

4. The method of claim 1 wherein the associating comprising forming a data structure that comprises a coordinate field and a communications information field.

5. The method of claim 1 wherein the operations information associated with the coordinate of the subterranean formation comprises operations information for a drilling operation.

6. The method of claim 5 wherein the coordinate of the subterranean formation comprises a drill bit depth.

7. The method of claim 1 further comprising associating modeling information with the coordinate, indexing the modeling information and storing a search index based at least in part on the indexing of the modeling information.

8. The method of claim 7 wherein the modeling information comprises modeling information for a model of the subterranean formation.

9. The method of claim 1 wherein the coordinate comprises a well depth for a well in the subterranean formation.

10. A system comprising:
a processor;
memory operatively coupled to the processor;
modules stored in the memory that comprise processor-executable instructions wherein the modules comprise
an operations module to acquire operations information for an operation associated with a coordinate of a subterranean formation;
a communications module to acquire communications information for a communication associated with a time;
an association module to associate the coordinate of the subterranean formation and the time of the communication; and
a search index module to index the acquired operations information and communications information and the coordinate of the subterranean formation or the time of the communication.

11. The system of claim 10 wherein the search index module to index indexes the coordinate of the subterranean formation and the time of the communication.

12. The system of claim 10 wherein the communication occurs during the operation.

13. The system of claim 10 further comprising a structure module to form a data structure that comprises a coordinate field for the coordinate, a time field for the time or a coordinate field for the coordinate and a time field for the time.

14. The system of claim 13 wherein the data structure comprises a communications information field for the communications information.

15. The system of claim 13 wherein the data structure comprises an operations information field for the operations information.

16. One or more computer-readable media comprising computer-executable instructions to instruct a computer to:
provide a search index that comprises indexed operations information for an operation in a well in a subterranean formation, coordinate information for a depth in the well, and communications information associated with the well in the subterranean formation for a communication occurring at a time of an operation performed at the depth in the well;
receive a query;
identify one or more matches for the query using the search index; and
transmit one or more results responsive to the query based at least in part on the one or more matches.

17. The one or more computer-readable media of claim 16 comprising computer-executable instructions to instruct a computer to parse the query wherein the query comprises search criteria.

18. The one or more computer-readable media of claim 16 comprising computer-executable instructions to instruct a computer to identify one or more matches based at least in part on a term of the query and a term in the indexed communications information.

19. The one or more computer-readable media of claim 16 comprising computer-executable instructions to instruct a computer to update the search index based at least in part on operations information for an operation in another well in the subterranean formation, coordinate information for a depth in the other well, and communications information associated with the other well in the subterranean formation for a communication occurring at a time of an operation performed at the depth in the other well.

20. The one or more computer-readable media of claim 16 comprising computer-executable instructions to instruct a computer to transmit the one or more results as URLs.
